(19) United States
(12) Patent Application Publication
(10) Pub. No.: US 2017/0082137 A1
(43) Pub. Date: Mar. 23, 2017

(54) DRIVESHAFT FOR A ROTARY SYSTEM

(71) Applicant: ROHR, INC., Chula Vista, CA (US)

(72) Inventors: Sreenivas Narayanan Nampy, San Diego, CA (US); Matthew J. Smelcer, Middleburg, FL (US)

(21) Appl. No.: 14/861,823

(22) Filed: Sep. 22, 2015

(51) Int. Cl. F16C 1/02

(52) U.S. Cl. CPC F16C 1/02

(57) ABSTRACT

A composite driveshaft includes a body having a first end, a second end, and an intermediate portion defining a driveshaft axis. The first end defines a first coupling region and the second end defines a second coupling region. At least one virtual hinge is arranged adjacent at least one of the first coupling region and the second coupling region. The at least one virtual hinge being defined by a plurality of axially extending openings forming a plurality of axially extending flexible material webs that accommodate both bending moments and axial changes of the body.

### BACKGROUND

Exemplary embodiments pertain to the art of rotary systems and, more particularly, to a composite driveshaft for a rotary system.

In a rotary drive system, a driveshaft may be used to transfer torque from a rotating driving component to a rotating driven component. it is common to use U-joints or other misalignment compensating devices. A U-joint, for example, might be placed at each end or intermediate locations of the driveshaft, forming part of the connection between the driveshaft and the driving component and between the driveshaft and the driven component. Many types of misalignment compensating devices are known. Basically, they function to ensure the driveshaft is loaded only with torque, and they minimize any bending and compressive or tensile deformations. One advantage is that by limiting bending stresses fatigue life of the driveshaft is especially increased. Any misalignment can result in significant undesirable stresses in the absence of misalignment compensating devices and lead to heavier designs to accommodate for these stresses.

This invention is relevant to lightweight rotary drive systems applications, which may be especially advantageous in the aerospace industry. For example, a helicopter has a driveshaft that drives a tail rotor. There are numerous other examples of rotary drive systems in rotary wing and fixed wing aircraft. In aerospace applications, weight is a disadvantage. A driveshaft with traditional U-joints or other traditional misalignment compensating devices may be heavier and mechanically complex than desired for the rotary drive system. This invention provides a lightweight driveshaft with an integrated misalignment compensating feature, which may be made from composite materials to further minimize weight.

### BRIEF DESCRIPTION

Disclosed is a composite driveshaft including a body having a first end, a second end, and an intermediate portion defining a driveshaft axis. The first end defines a first coupling region and the second end defines a second coupling region. At least one virtual hinge is arranged adjacent at least one of the first coupling region and the second coupling region. The at least one virtual hinge being defined by a plurality of axially extending openings forming a plurality of axially extending flexible material webs that accommodate both bending and axial changes of the body.

### BRIEF DESCRIPTION OF THE DRAWINGS

The following descriptions should not be considered limiting in any way. With reference to the accompanying drawings, like elements are numbered alike:

FIG. 1 depicts a side view of a rotary wing aircraft having a driveshaft, in accordance with an exemplary embodiment;

FIG. 2 is an upper perspective view of the rotary wing aircraft of FIG. 1;

FIG. 3 depicts a drive system of the rotary wing aircraft of FIG. 1 including a composite driveshaft, in accordance with an exemplary embodiment;

FIG. 4 depicts a partial perspective view of a portion of the driveshaft of FIG. 3;

FIG. 5 depicts a partial side view of the driveshaft of FIG. 4 absorbing a bending stress, in accordance with an exemplary embodiment;

FIG. 6 depicts a partial perspective view of the driveshaft of FIG. 4 absorbing an axial tensile load, in accordance with an exemplary embodiment;

FIG. 7 depicts a partial perspective view of the driveshaft of FIG. 4 absorbing an axial compressive load, in accordance with an exemplary embodiment;

FIG. 8 depicts a graph representing torsional stiffness of a portion of the driveshaft, in accordance with an exemplary embodiment;

FIG. 9 depicts a graph representing bending stiffness of a portion of the driveshaft, in accordance with an exemplary embodiment;

FIG. 10 depicts a graph representing axial stiffness of a portion of the driveshaft, in accordance with an exemplary embodiment;

FIG. 11 depicts a side sectional view of a driveshaft, in accordance with an aspect of an exemplary embodiment;

FIG. 12 depicts an end view of the driveshaft of FIG. 10; and

FIG. 13 depicts a partial cross-sectional view of a portion of the driveshaft of FIG. 11, in accordance with an exemplary embodiment.

### DETAILED DESCRIPTION

A detailed description of one or more embodiments of the disclosed apparatus and method are presented herein by way of exemplification and not limitation with reference to the Figures.

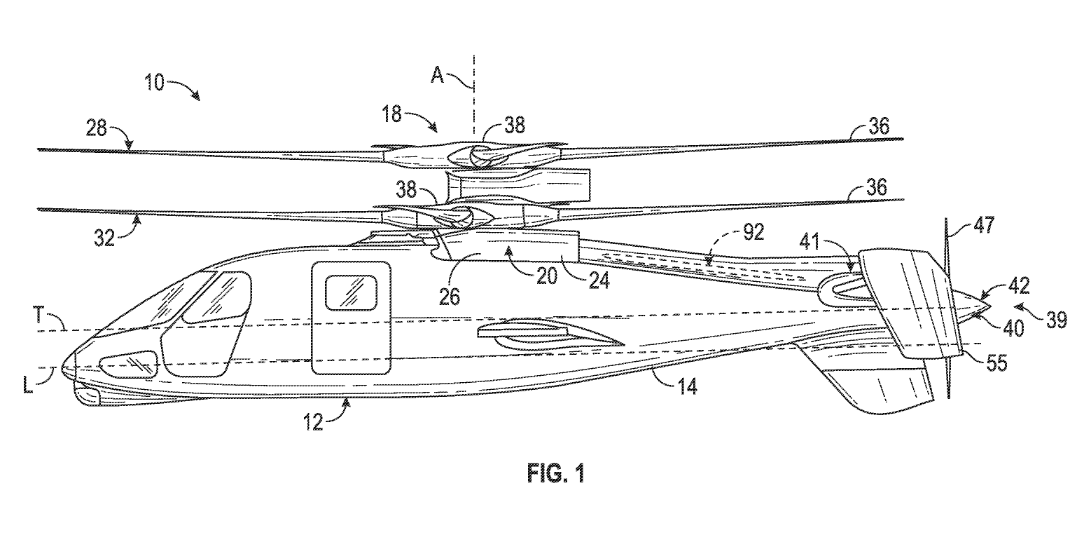

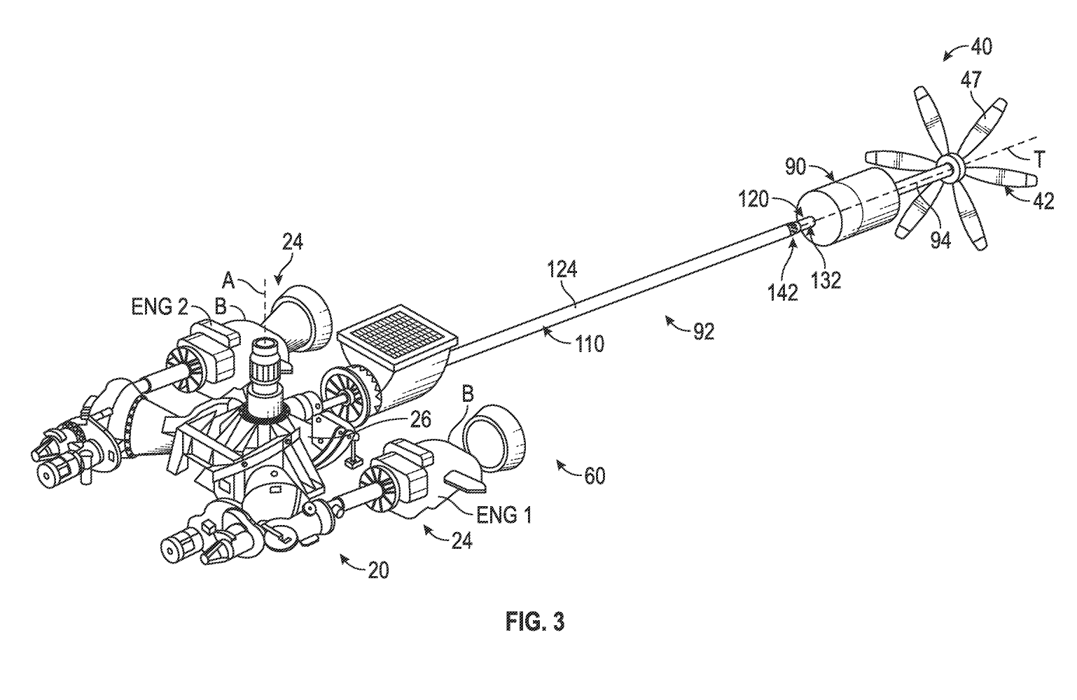

FIG. 1 depicts an exemplary embodiment of a rotary wing, vertical take-off and land (VTOL) aircraft 10. The aircraft 10 includes an airframe 12 with an extending tail 14. A dual, counter rotating, coaxial main rotor assembly 18 is located at the airframe 12 and rotates about a main rotor axis, A. The main rotor assembly 18 is driven by a multi-engine power plant 20, including, one or more engines 24 (ENG 1 and ENG 2) (FIG. 3) via a main gearbox (MGB) 26. The main rotor assembly 18 includes an upper rotor assembly 28 driven in a first direction (e.g., counter-clockwise) about the main rotor axis, A, and a lower rotor assembly 32 driven in a second direction (e.g., clockwise) about the main rotor axis, A, opposite to the first direction (i.e., counter rotating rotors). Each of the upper rotor assembly 28 and the lower rotor assembly 32 includes a plurality of rotor blades 36 secured to a rotor hub 38. Of course, it should be understood that the above description provides one example of a rotary wing aircraft platform, exemplary embodiments described herein are not limited to multi-rotor systems.

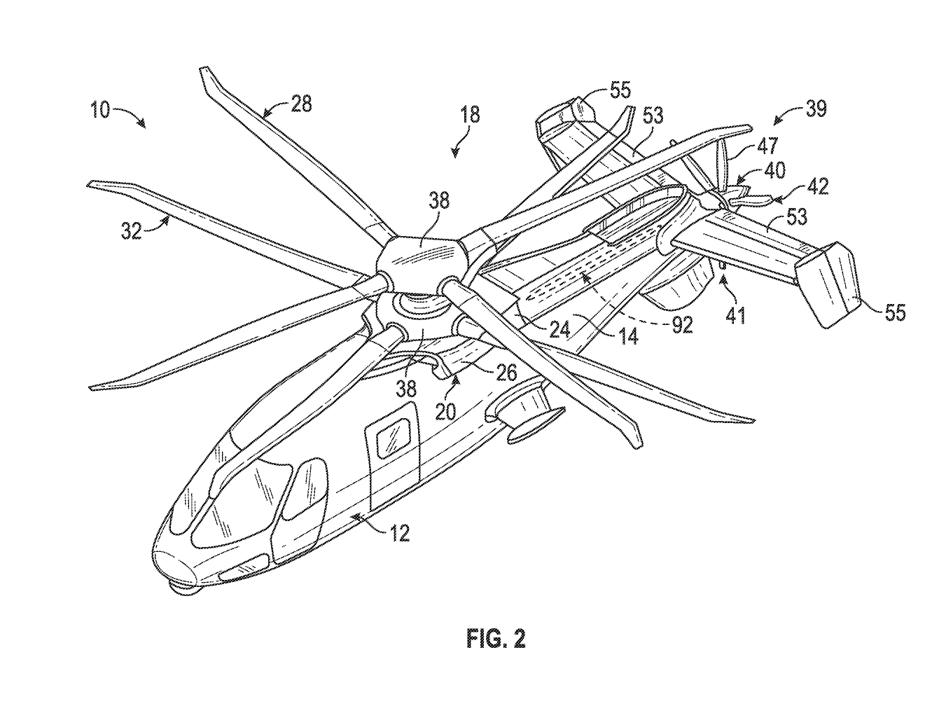

In some embodiments, the aircraft 10 further includes a tail rotor system 39, shown in the form of a translational thrust system 40, located at the extending tail 14. Translational thrust system 40 may provide translational thrust (forward or rearward) for aircraft 10. Referring to FIG. 2, translational thrust system 40 includes a propeller 42 and is positioned at a tail section 41 of the aircraft 10. Propeller 42 includes a plurality of propeller blades 47. In exemplary embodiments, the pitch of propeller blades 47 may be altered to change the direction of thrust (e.g., forward or rearward). The tail section 41 includes active elevators 53 and active rudders 55 as controllable surfaces. Of course, it should be understood that tail rotor system 39 may also represent a conventional system configured to counter a torque effect generated by main rotor assembly 18.

Referring to FIG. 3, the main rotor assembly 18 is driven about the axis of rotation, A, through MGB 26 by multi-engine power plant 20. Although FIG. 3 depicts two engines 24, it is understood that aircraft 10 may use a single engine 24. Multi-engine power plant 20 generates power available for flight operations and couples such power to the main rotor assembly 18 and the translational thrust system 40 through a drive system 60. The MGB 26 may be interposed between multi-engine power plant 20, main rotor assembly 18, and translational thrust system 40. A portion of the drive system 60, downstream of the MGB 26, includes a combined gearbox 90 (also referred to as a clutch). Combined gearbox 90 selectively operates as a clutch and a brake for operation of the translational thrust system 40 with MGB 26. Combined gearbox 90 also operates to provide a rotor brake function for main rotor assembly 18.

Combined gearbox 90 generally includes an input 92 and an output 94 generally defined along an axis parallel to rotational axis, T. Input 92 is generally upstream of the combined gearbox 90 relative MOB 26 and output 94 is downstream of the combined gearbox 90 and upstream of translational thrust system 40 (FIG. 2). It should be understood that various combined gearbox systems may be utilized to include, but not be limited to, mechanical, electrical, hydraulic and various combinations thereof.

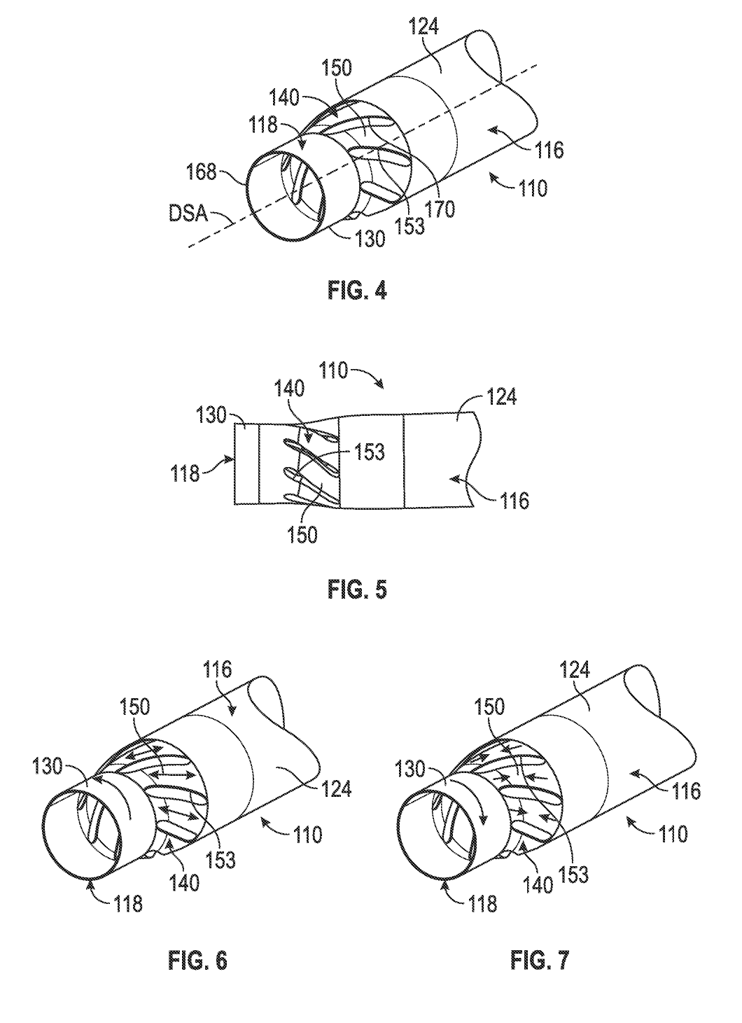

In accordance with an aspect of an exemplary embodiment, input 92 takes the form of a composite driveshaft 110. Of course, it should be understood, that output 94 could also take the form of a composite driveshaft. Composite driveshaft 110 includes a body 116 having a first end 118 (FIG. 4), a second end 120 and an intermediate portion 124 extending therebetween and defining a driveshaft axis (DSA). First end 118 defines a first coupling region 130 operatively connected to MGB 26 and second end 120 defines a second coupling region 132 operatively connected to combined gearbox 90. First and second coupling regions 130 and 132, as well as intermediate portion 124, may be optionally formed from one or more braided fiber laminate layers (not separately labeled).

In accordance with an exemplary embodiment, composite driveshaft 110 includes a first virtual hinge 140 arranged adjacent to first coupling region 130 and a second virtual hinge 142 arranged adjacent to second coupling region 132. At this point, it should be understood that the term “virtual hinge” describes a portion of composite driveshaft 110 that may bend, compress and/or extend in response to bending, axial, and tensile forces on composite driveshaft 110. Further, the term “virtual hinge” should be understood to accommodate such forces without mechanical linkages commonly associated with mechanical hinges; instead, the “virtual hinge” relies on material properties and geometry of one or more portions of body 116. More specifically, a virtual hinge (or an elastic hinge) and a mechanical hinge differ in that the mechanical hinge provides rigid body rotation whereas a virtual hinge (or elastic hinge) utilizes elastic deformation of a component.

Reference will now follow to FIGS. 5-7 in describing first virtual hinge 140 with an understanding that second virtual hinge 142 may include similar structure and may be designed to function in a similar manner. In accordance with an exemplary embodiment, first virtual hinge 140 includes one or more flexible material webs 150 formed by one or more extending openings 153 extending through body 116. In accordance with an aspect of an exemplary embodiment, extending openings 153 constitute slotted openings extending axially along the DSA. In accordance with another aspect of an exemplary embodiment, the slotted openings extend along, and at a non-zero angle relative to, the DSA. In accordance with another aspect of an exemplary embodiment, the non-zero angle may be about 45-degrees. Flexible material web 150 extends axially along the DSA and may be formed from a variety of materials including flexible matrix composite (FMC) materials, rigid matrix composite (RMC) materials, metals and/or hybrids including one or more of FMC, RMC, and metals. Further, material web 150 may be formed of one or more material sheets or laminates (not separately labeled) formed from FMC, RMC, metals and/or hybrids thereof Still further, the one or more material sheets may include unidirectional fibers (also not separately labeled). It should be understood that all or a portion of the fibers that form webs 150 may extend continuously from the middle of the driveshaft, through the webs, to the coupling regions.

In further accordance with an exemplary embodiment, first and second coupling regions 130 and 132 may be formed from a braided fiber laminate material having a first thickness 168 and material web(s) 150 may include a second thickness 170 that is less than the first thickness 168. The additional thickness of first and second coupling regions 130 and 132 may provide added resiliency at high stress areas, e.g., attachment points of composite driveshaft 110. Of course, it should be understood that first and second coupling regions 130 and 132 may also be formed from a material that is as thick as, or thinner than, material web(s) 150.

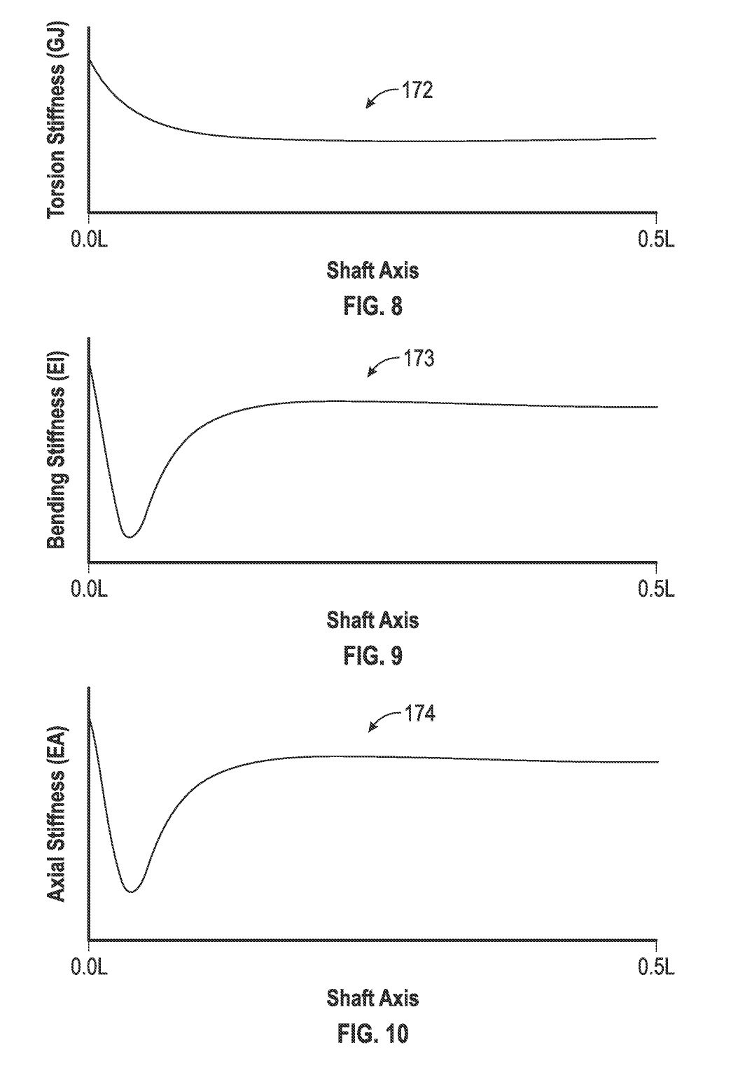

In this manner, composite driveshaft 110 may possess desirable torsional stiffness, such as is shown at 172 in FIG. 8, to transmit torque along its length, while also providing desirable bending stiffness at each of first and second ends 118 and 120, such as is shown at 173 in FIG. 9, and axial stiffness at first and second end 118 and 120, such as shown at 174 in FIG. 10. The presence of virtual hinges 140 and 142 allows composite driveshaft 110 to accommodate various positional changes of extending tail 14 relative to airframe 12 without adding weight, as would be provided with conventional hinge elements such as universal joints and the like.

Further, FIG. 8 illustrates that the overall torsion stiffness remains steady away from virtual hinge 140 and first coupling region 130 thereby avoiding undesirable relative twisting along composite driveshaft 110 all while maintaining flexible material webs 150 at a relatively lower bending and axial stiffness to accommodate misalignments. However, it should be noted that the individual segments are designed to provide necessary bending stiffness in the circumferential direction to generate the desired torsional rigidity when plurality of such segments 150 are arranged in a tubular configuration 140. A large strain-at-failure material can be used such as FMC or a hybrid material to accommodate various misalignments. The desired proprieties are achieved through careful selection of geometry, material system, fiber orientation, and segment thickness. The designs are such that the behavior of virtual hinge 140 remains elastic. That is, bending of virtual hinge 140 does not result in any permanent deformation.

Further, the geometry of composite driveshaft 110 includes the tube diameter (not separately labeled) at virtual hinge 140, thickness of flexible material webs 150 along their length, orientation (angle) of each flexible material web 150 with respect to the DSA, and the overall length of virtual hinge 140.

Further, virtual hinge 140 may be formed from FMC, RMC, metals, and/or hybrids thereof as noted above. Fiber direction in composite driveshaft 110 can be manipulated to tailor the structure. Flexible material webs 150 may be made of unidirectional fibers and or multidirectional lay-ups. The thickness of each flexible material web 150 can also vary within each web. A lay-up process to form each flexible material web 150 may begin well inboard of virtual hinge 140 and extend through virtual hinge 140 into first coupling region 130. The arrangement of openings 153 provides for, or facilitates independent movement of each flexible material web.

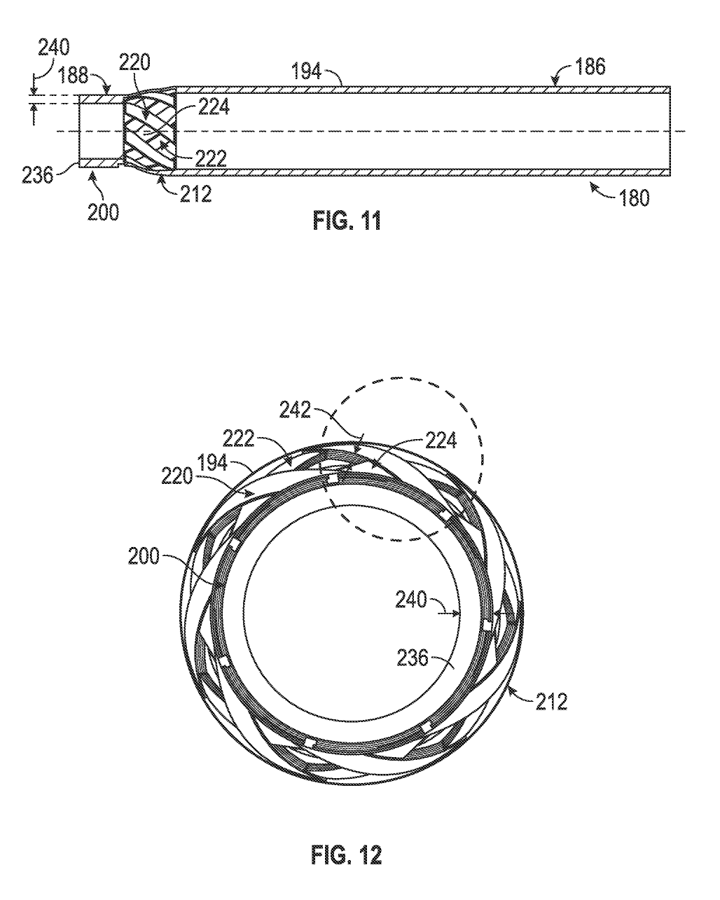

Reference will now follow to FIG. 11 in describing a composite driveshaft 180 in accordance with another aspect of an exemplary embodiment. Composite driveshaft 180 includes a body 186 having a first end 188, a second end (not shown) and an intermediate portion 194 defining a driveshaft axis (DSA) extending therebetween. First end 188 defines a first coupling region 200 while the second end defines a second coupling region (also not shown). First coupling region 200 as well as the second coupling region and intermediate portion 194 may be formed from one or more braided fiber laminate layers (not separately labeled). First coupling region 200 may interface with MGB 26 and the second coupling region may interface with combined gearbox 90. Composite driveshaft 180 includes a virtual hinge 212 arranged adjacent to first coupling region 200. A second virtual hinge (not shown) may be present adjacent the second coupling region.

In accordance with an aspect of an exemplary embodiment show in FIG. 12, virtual hinge 212 includes a first plurality of material webs 220 and a second plurality of material webs 222. First plurality of material webs 220 extend along the DSA at a first angle and second plurality of material webs 222 extend along the DSA at a second angle. First and second pluralities of material webs 220 and 222 may be formed from a variety of materials including flexible matrix composite (FMC) materials, rigid matrix composite (RMC) materials, metals and/or hybrids including one or more of FMC, RMC, and metals. Further, first and second pluralities of material webs 220 and 222 may be formed of one or more material sheets or laminates (not separately labeled) formed from FMC, RMC, metals and/or hybrids thereof Still further, the one or more material sheets may include unidirectional fibers (also not separately labeled).

In accordance with an aspect of an exemplary embodiment, first and second pluralities of material webs 220 and 222 cross one another forming a plurality of openings 224. In accordance with an aspect of an exemplary embodiment, each of the first plurality of material webs 220 is formed from a first plurality of plys or sheets 230. Similarly, each of the second plurality of material webs 222 is formed from a second plurality of plys or sheets 232. It should be understood that all or a portion of the fibers that form webs 220 and 222 may extend continuously from the middle of the driveshaft, through the webs, to the coupling regions.

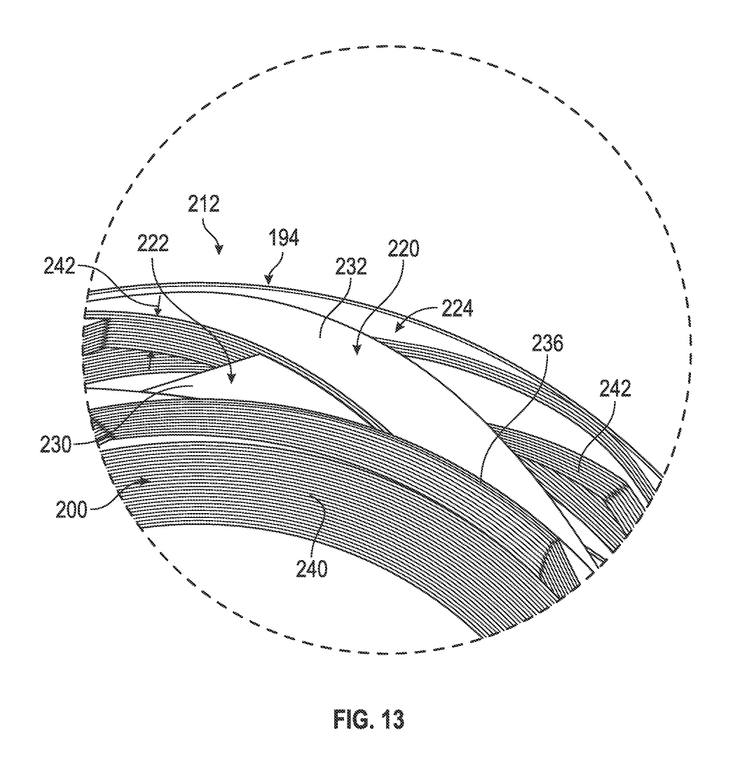

In accordance with an aspect of an exemplary embodiment, sheets 230 and sheets 232 are interleaved or interwoven, as shown in FIG. 13, to promote desirable strength and ductility properties of virtual hinge 212. In further accordance with an aspect of an exemplary embodiment, first coupling region 200 is formed from a braided fiber sheet 236 that provides desirable strength properties. The plies making this sheet 236 may be placed under or over the interleaved or interwoven web plies 230 and 232 to tie them together. In still further accordance with an exemplary embodiment, first coupling region 200 includes a first thickness 240, and each of the first and second pluralities of material webs 220 and 222 include a second thickness 242. In the exemplary embodiment shown, first thickness 240 is greater than second thickness 242. The additional thickness of first (and second) coupling region 200 may provide added resiliency at high stress areas, e.g., attachment points of composite driveshaft 180. Of course, it should be understood that first (and second) coupling region 200 may also be formed from a material that is as thick as, or thinner than, first and second pluralities of material webs 220 and 222.

In this manner, composite driveshaft 180 may possess desirable torsion stiffness to transmit torque from engines 24 to propeller 42, while also providing desirable bending stiffness at each of first end 188 and the second end (not shown) and axial stiffness at first end 188 and the second end (not shown). The presence of virtual hinge 212 allows composite driveshaft 180 to accommodate various positional changes of extending and laterally translating tail 14 relative to airframe 12 without adding weight and mechanical complexity, as would be provided with conventional hinge elements such as universal joints and the like.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof Therefore, it is intended that the present disclosure not be limited to the particular embodiment disclosed as the best mode contemplated for carrying out this present disclosure, but that the present disclosure will include all embodiments falling within the scope of the claims.

We claim:

1. A composite driveshaft comprising:
a body including a first end, a second end, and an intermediate portion defining a driveshaft axis, the first end defining a first coupling region and the second end defining a second coupling region; and
at least one virtual hinge arranged adjacent at least one of the first coupling region and the second coupling region, the at least one virtual hinge being defined by a plurality of axially extending openings forming a plurality of axially extending flexible material webs that accommodate both bending and axial changes of the body.

2. The composite driveshaft according to claim 1, wherein each of the plurality of axially extending flexible material webs extends at an angle relative to the axial axis.

3. The composite driveshaft according to claim 2, wherein the angle is about 45-degrees.

4. The composite driveshaft according to claim 1, wherein at least one of the intermediate portion and the one of the first and second coupling regions includes a braided fiber laminate layer.

5. The composite driveshaft according to claim 4, wherein each of the plurality of axially extending, twisting, and bending flexible material webs is formed from a material having unidirectional fibers.

6. The composite driveshaft according to claim 5, wherein the material forming each of the axially extending, twisting, and bending flexible material webs comprises one of a flexible matrix composite material (FMC), a rigid matrix composite material (RMC), a metallic material, fiber reinforced metal matrix composite material (MMC), and a hybrid FMC/RMC/metal/MMC material.

7. The composite driveshaft according to claim 1, wherein each of the plurality of axially extending, twisting, and bending flexible material webs comprises a first material web extending at a first angle relative to the axial axis and a second material web extending at a second angle relative to the axial axis, the first material web extending across the second material web.

8. The composite driveshaft according to claim 7, wherein the first material web is formed from a first plurality of material sheets and the second material web is formed from a second plurality of material sheets, the first plurality of material sheets being interleaved with the second plurality of material sheets.

9. The composite driveshaft according to claim 7, wherein the first material web is formed from a first plurality of material sheets formed from a unidirectional fiber and the second material web is formed from a second plurality of material sheets formed from a unidirectional fiber.

10. The composite driveshaft according to claim 1, wherein the one of the first and second coupling regions includes a first thickness and the virtual hinge includes a second thickness, the first thickness being greater than or less than or equal to the second thickness.
